(19) United States
(12) Patent Application Publication
(10) Pub. No.: US 2024/0011756 A1
(43) Pub. Date: Jan. 11, 2024

(54) ESTIMATION METHOD FOR NUGGET DIAMETER AND DETERMINATION METHOD

(71) Applicant: TOYOTA JIDOSHA KABUSHIKI KAISHA, Toyota-shi (JP)

(72) Inventors: Shuhei OGURA, Nagakute-shi (JP); Tomohiko SEKIGUCHI, Nagakute-shi (JP); Kyosuke IZUNO, Nissin-shi (JP); Yuki MATSUGI, Toyota-shi (JP); Shota EJIMA, Nagoya-shi (JP); Yasuaki OKITA, Chiba-shi (JP); Mizuki KODAMA, Yukuhashi-shi (JP)

(73) Assignee: TOYOTA JIDOSHA KABUSHIKI KAISHA, Toyota-shi (JP)

(21) Appl. No.: 18/143,929

(22) Filed: May 5, 2023

(30) Foreign Application Priority Data
Jul. 7, 2022 (JP) 2022-109710

(51) Int. Cl. G01B 7/12; G01B 7/06; B23K 11/11

(52) U.S. Cl. CPC G01B 7/12; G01B 7/06; B23K 11/11

(57) ABSTRACT

Resistance spot welding includes a first process of performing energization by pressurizing two or more metal plates superposed by sandwiching a pair of electrode tips, and a second process of stopping energization in the first process and pressurizing two or more metal plates by a pair of electrode tips. The estimation method for the nugget diameter includes: a thickness estimation process of estimating the nugget thickness using the amount of expansion in the thickness direction of two or more metal plates in the first process and the electric resistance value between the pair of electrode tips in the first process; and a diameter estimation process of estimating the nugget diameter using the expansion amount and the electric resistance value when the nugget is estimated to have reached the interface between two adjacent metal plates using the respective thicknesses of the two or more metal plates and the estimated nugget thickness.

### CROSS-REFERENCE TO RELATED APPLICATION

This application claims priority to Japanese Patent Application No. 2022-109710 filed on Jul. 7, 2022, incorporated herein by reference in its entirety.

### BACKGROUND

### 1. Technical Field

The present disclosure relates to an estimation method for a nugget diameter and a determination method.

### 2. Description of Related Art

Conventionally, a method is known in which a plurality of metal plates laminated is welded by spot welding (for example, WO2017/212916). In spot welding, the vicinity of the surface to be bonded of each metal plate is melted by heat generation caused by energization. After that, the molten metal plates solidify, and the metal plates are welded. A nugget diameter of a nugget formed by solidifying the molten metal can be used as an index for evaluating a welding quality such as a bonding strength.

### SUMMARY

It has been attempted that, instead of actual measurement of the nugget diameter, a physical quantity that changes in the process of welding is measured, and the nugget diameter is estimated using the measured physical quantity. On the basis of this, it is required to improve the estimation accuracy of the nugget diameter.

The present disclosure can be realized in the following aspects.

(1) According to an aspect of the present disclosure, an estimation method for a nugget diameter of a nugget formed by resistance spot welding is provided. The resistance spot welding according to the estimation method includes a first process and a second process. The first process is a process of pressurizing two or more metal plates that are laminated by being interposed between paired electrode tips and applying energization. The second process is a process of stopping the energization in the first process and pressurizing the two or more metal plates with the paired electrode tips. The estimation method includes: a thickness estimation process of estimating a nugget thickness using an expansion amount in a thickness direction of the two or more metal plates in the first process and an electric resistance value between the paired electrode tips in the first process; and a diameter estimation process of estimating the nugget diameter using the expansion amount and the electric resistance value when the nugget is estimated to reach an interface between two of the metal plates adjacent to each other using a thickness of each of the two or more metal plates and the estimated nugget thickness.

According to this aspect, it is possible to exclude estimation of the nugget diameter with low accuracy that is calculated when the nugget does not reach the interface. Therefore, it is possible to improve the estimation accuracy of the estimated nugget diameter.

(2) In the estimation method according to the above aspect, the thickness estimation process may include estimating the nugget thickness using a contraction amount in the thickness direction of the two or more metal plates in the second process, in addition to the expansion amount and the electric resistance value.

The diameter estimation process may include estimating the nugget diameter using the contraction amount, in addition to the expansion amount and the electric resistance value. In the second process, expansion of the metal plate is stopped as the energization is stopped. Pressurization by the electrode tips causes the molten portion to contract in the thickness direction and expand in the interface direction. Therefore, according to this aspect, estimation of the nugget diameter using the contraction amount makes it possible to reflect the expansion amount of the nugget that is the molten portion in the interface direction in the second process. Therefore, the estimation accuracy can be further improved.

(3) In the estimation method according to the above aspect, the contraction amount may be a value obtained by subtracting a thickness of the two or more metal plates at an end of the second process from a thickness of the two or more metal plates at a start of the second process.

According to this aspect, the value obtained by subtracting the thickness at the end of the second process from the thickness of the two or more metal plates at the start of the second process can be used as the contraction amount. It is possible to reduce the load required for calculation of the contraction amount.

(4) In the estimation method according to the above aspect, the electric resistance value may be an average of the electric resistance value from a time point returned from a time point at an end of the first process by a predetermined acquisition time to the time point at the end, and the acquisition time may be less than or equal to half a process time of the first process. The average of the electric resistance value from a time point returned from the time point at a start of the second process by the predetermined acquisition time to the time point at the start of the second process and each of the nugget thickness and the nugget diameter have a good correlation with each other. Therefore, according to this aspect, it is possible to further improve the estimation accuracy of each of the nugget thickness and the nugget diameter.

(5) The estimation method according to the above aspect may further include estimating that the nugget reaches the interface when a half length of the estimated nugget thickness is longer than a distance between a center position in the thickness direction of the two or more metal plates and the interface that is farthest away from the center position.

According to this aspect, it can be estimated that the nugget reaches the interface when the half length of estimated nugget thickness is longer than the distance between the center position in the thickness direction of the two or more metal plates and the interface that is farthest from the center position.

(6) In the estimation method according to the above aspect, when the nugget thickness is NT (mm), the nugget diameter is ND (mm), the expansion amount is E (mm), the contraction amount is S (mm), the electric resistance value is R (Ω), and predetermined constants are C1 to C8, the thickness estimation process may include obtaining the nugget thickness using an equation (1) below, and the diameter estimation process may include obtaining the nugget diameter using an equation (2), where

NT=C1×E+C2×S+C3×R+C4 (1)

ND=C5×E+C6×S+C7×R+C8 (2).

The nugget thickness and the nugget diameter are in a proportional relationship with each of the expansion amount, the contraction amount, and the electric resistance value. Therefore, according to this aspect, the nugget thickness and the nugget diameter can be estimated using the equations (1) and (2).

(7) A determination method using the estimation method of the above aspect may include determining that a welding failure occurs when the nugget is estimated not to reach the interface using the thickness of each of the two or more metal plates and the estimated nugget thickness.

According to this aspect, it is possible to appropriately determine the welding quality.

The present disclosure can also be implemented in various forms other than the estimation method. For example, the present disclosure can be implemented in the form of an estimation device, a control method of the estimation device, a computer program for realizing the control method, a non-transitory recording medium in which the computer program is recorded, and the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a schematic configuration of a resistance spot welding device according to an embodiment;

FIG. 2 is a diagram showing a relationship between a time and a displacement amount in a welding process;

FIG. 3 is a schematic view showing a cross section of a welded member in each process of welding;

FIG. 4 is a diagram for explaining a case where accuracy of an estimation formula is insufficient;

FIG. 5 is a diagram showing a relationship between an actual nugget diameter and an expansion amount;

FIG. 6 is a diagram showing a relationship between an actual nugget diameter and a contraction amount;

FIG. 7 is a diagram showing a relationship between an actual nugget diameter and an electric resistance value;

FIG. 8 is a flowchart of a nugget diameter estimation process;

FIG. 9: Estimation of the length of half the nugget thickness;

FIG. 10 is a graph showing an estimation of a nugget diameter according to Embodiment 1; and

FIG. 11 shows the result of estimating the nugget diameter according to Example 2.

### DETAILED DESCRIPTION OF EMBODIMENTS

### A. Embodiment

### A1. Configuration of Resistance Spot Welder

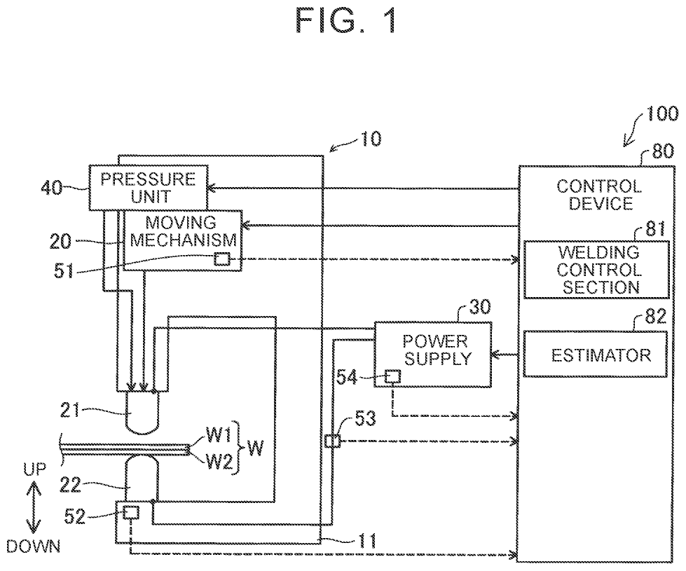

FIG. 1 is a schematic diagram illustrating a schematic configuration of a resistance-spot welding device 100. In the following description, the vertical direction shown in FIG. 1 is used. The up-down direction is parallel to the up-down direction in which the electrode tip 21, which is a movable electrode, moves up and down. The electrode tip 21 will be described later.

The resistance spot welding device 100 welds a welded member W in which two or more metal plates are superposed. FIG. 1 illustrates an example in which the first metal plate W1, which is two or more metal plates, and the second metal plate W2 are superposed on each other as the welded member W. The resistance spot welding device 100 includes a welding gun 10, a power supply device 30, and a control device 80.

The welding gun 10 is attached to a distal end of a robot arm (not shown). The gun body 11 is moved by the robot arm to the target welding point of the welded member W. The welding gun 10 includes a gun body 11, a moving mechanism 20, a pair of electrode tips 21 and 22, and a pressurizing device 40. The gun body 11 has a U-shape. A pair of electrode tips 21, 22 is attached to the gun body 11. Among the pair of electrode tips 21 and 22, one electrode tip 21 is a movable electrode. The electrode tip 21 is attached to an upper portion of the gun body 11. Of the pair of electrode tips 21 and 22, the other electrode tip 22 is a fixed electrode. The electrode tip 22 is attached at a position facing the electrode tip 21 at the lower portion of the gun body 11.

The moving mechanism 20 raises and lowers the electrode tip 21. The moving mechanism 20 includes a servo motor (not shown). The moving mechanism 20 converts the rotational force of the servo motor into a linear moving force in the elevating direction. The moving mechanism 20 transmits the converted linear movement force to the electrode tip 21. Accordingly, the moving mechanism 20 raises and lowers the electrode tip 21. The power supply device 30 supplies a welding current between the pair of electrode tips 21 and 22. The welding current is a target current value. The pressurizing device 40 includes a cylinder (not shown). The pressurizing device 40 presses the electrode tip 21 against the welded member W.

The resistance spot welding device 100 further includes an encoder 51, a strain gauge 52, a current sensor 53, and a voltage sensor 54. The encoder 51 detects the rotation amount of the servo motor of the moving mechanism 20 at predetermined time intervals. The encoder 51 transmits a signal indicating the detected rotation amount to the control device 80. The strain gauge 52 is mounted near the electrode tip 22. The strain gauge 52 detects the amount of displacement caused by the external force at predetermined time intervals. The strain gauge 52 transmits a signal indicating the amount of displacement to the control device 80. As will be described later, the encoder 51 and the strain gauge 52 are used to detect the amount of change in the distance between the pair of electrode tips 21 and 22.

The current sensor 53 detects the current value of the welding current supplied from the power supply device 30 at predetermined time intervals. The current sensor 53 transmits a signal indicating the current value to the control device 80. The current sensor 43 is realized by using, for example, a toroidal coil. The voltage sensor 54 detects a voltage value between the electrode tip 21 and the electrode tip 22 at predetermined time intervals. The voltage sensor 54 transmits a signal indicating the voltage value to the control device 80.

The control device 80 is configured as a computer. The computer includes a processor (not shown), a storage device (not shown), an interface circuit (not shown), and the like. The interface provides signal communication between each sensor and the processor. The control device 80 includes a welding control unit 81 and an estimation unit 82 as functional units. The welding control unit 81 and the estimation unit 82 are realized by the processor of the control device 80 executing a program stored in the storage device. In each process described later of spot welding, the welding control unit 81 controls each unit such as the power supply device 30. After the spot-welding is completed, the estimation unit 82 estimates the nugget diameter ND of the nugget N, which will be described later. The nugget N is formed in the welding.

### A2. Weld Process

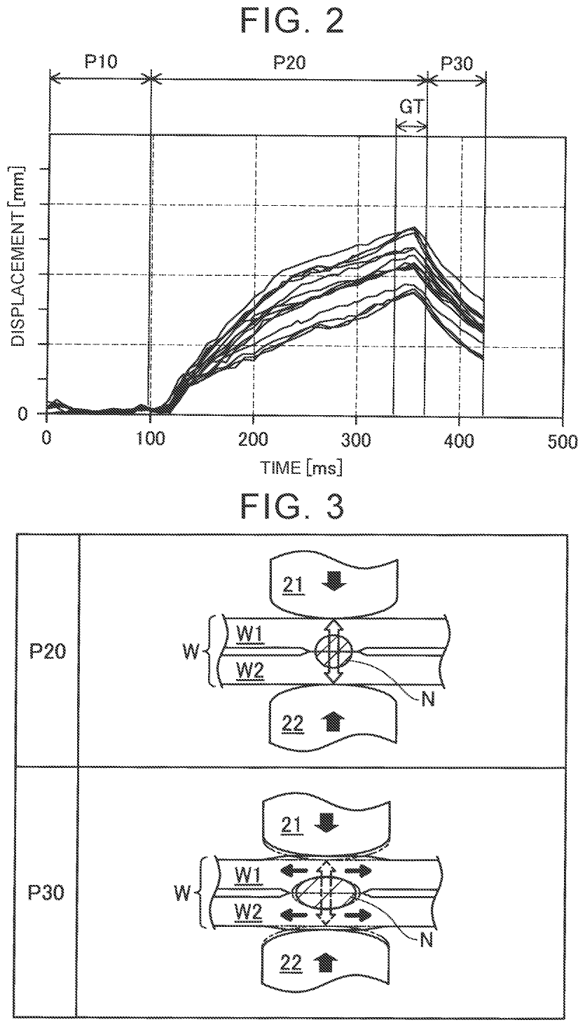

FIG. 2 is a diagram showing a relationship between the time in the welding process and the displacement amount which is the amount of change in the distance between the pair of electrode tips 21 and 22. The horizontal axis of FIG. 2 represents elapsed times (ms) based on the starting point of the preloading process P10. The vertical axis of FIG. 2 is the displacement (mm). The displacement amount data of FIG. 2 is data of each sample of Example 2 described later. FIG. 3 is a schematic view showing a state of a cross section of the welded member W in each process of welding.

When the welding is started, in the preparation process, as shown in FIG. 1, the welding gun 10 is disposed at a position where the pair of electrode tips 21 and 22 sandwiches the welded member W and the electrode tip 22 contacts the lower surface of the second metal plate W2. Thereafter, the electrode tip 21 is lowered to a position contacting the upper surface of the first metal plate W1 by the moving mechanism 20.

Next, in the preloading process P10 shown in FIG. 2, the electrode tip 21 is pressed against the welded member W by the pressurizing device 40. As a result, the welded member W is pressurized at a target pressure. This pressurization is pressurization prior to energization. This pressurization is therefore also referred to as preload. Pressure is on the order of thousands of N. This makes it possible to stabilize the pressurization.

In the energization process P20, the two or more metal plates that are superimposed on each other are pressed and energized while being sandwiched between the pair of electrode tips 21 and 22. Specifically, in a state in which the welded member W is pressurized by the pair of electrode tips 21 and 22, a welding current is supplied between the pair of electrode tips 21 and 22, and energization is performed. As a result, Joule heat corresponding to the electric resistance value between the pair of electrode tips 21 and 22 is generated. By the Joule heat, melting of the metal starts from the vicinity of the center position in the thickness direction of the welded member W. As the energization period becomes longer, the nugget N, which is a molten metallic part, grows as shown in the energization process P20 of FIG. 3. In FIG. 3, the nugget N is indicated by a hatched line.

In the holding process P30 illustrated in FIG. 2, the energization in the energization process P20 is stopped, and two or more metal plates are pressurized by the pair of electrode tips 21 and 22. Specifically, the nugget N is sufficiently grown in the energization process P20. Thereafter, in the holding process P30, the energization between the pair of electrode tips 21 and 22 is stopped while the pressurization is maintained. As a result, the nugget N is cooled and the molten metal solidifies. Then, the first metal plate W1 and the second metal plate W2 are welded. After completion of the holding process P30, the electrode tip 21 is raised, and the pair of electrode tips 21 and 22 sandwiching the welded member W is released.

In the following explanation, the start point of the preloading process P10 is referred to as the weld start point. The process from the preloading process P10 to the holding process P30 is referred to as a weld process. The preloading process P10 is also referred to as a first process. The energization process P20 is also referred to as a second process.

The amount of displacement on the vertical axis in FIG. 2 is the amount of change in the distance between the encoder 51 and the pair of electrode tips 21 and 22 detected by the strain gauge 52. The displacement amount is a change amount when the distance between the pair of electrode tips 21 and 22 at the start of welding is zero.

As shown in the energization process P20 of FIG. 3, in the energization process P20, a force in a direction opposite to the pressurizing direction is applied to the pair of electrode tips 21 and 22 pressurized by the thermal expansion of the metal. The direction opposite to the pressurizing direction is a direction in which the pair of electrode tips 21 and 22 is widened as indicated by the outlined arrows in FIG. 3. Therefore, as shown in FIG. 2, in the energization process P20, the displacement-amount gradually increases as the nugget N grows.

Here, the energization process P20 will be described as an example, and methods for detecting the displacement-amount will be supplemented. As described above, in the energization process P20, a force in a direction opposite to the pressing direction is applied to the pair of electrode tips 21 and 22. Due to this force, the rotation axis of the servo motor included in the moving mechanism 20 rotates in a direction corresponding to the direction in which the electrode tip 21 ascends. Therefore, the displacement amount of the electrode tip 21 can be obtained by the rotation amount detected by the encoder 51. In addition, the position of the welding gun 10 changes from the start of welding due to the expansion of the welded member W. The strain gauge 52 detects the amount of change in this position. Therefore, the amount of change in the distance between the pair of electrode tips 21 and 22, that is, the amount of displacement can be detected by the detection value of the encoder 51 and the detection value of the strain gauge 52.

As shown in FIG. 2, during the holding process P30, the displacement is reduced. This is because, as shown in the holding process P30 of FIG. 3, the thermal expansion is accommodated by stopping the energization, rather than the force of expanding between the pair of electrode tips 21 and 22 due to thermal expansion, the pressurizing device is applied pressure is higher.

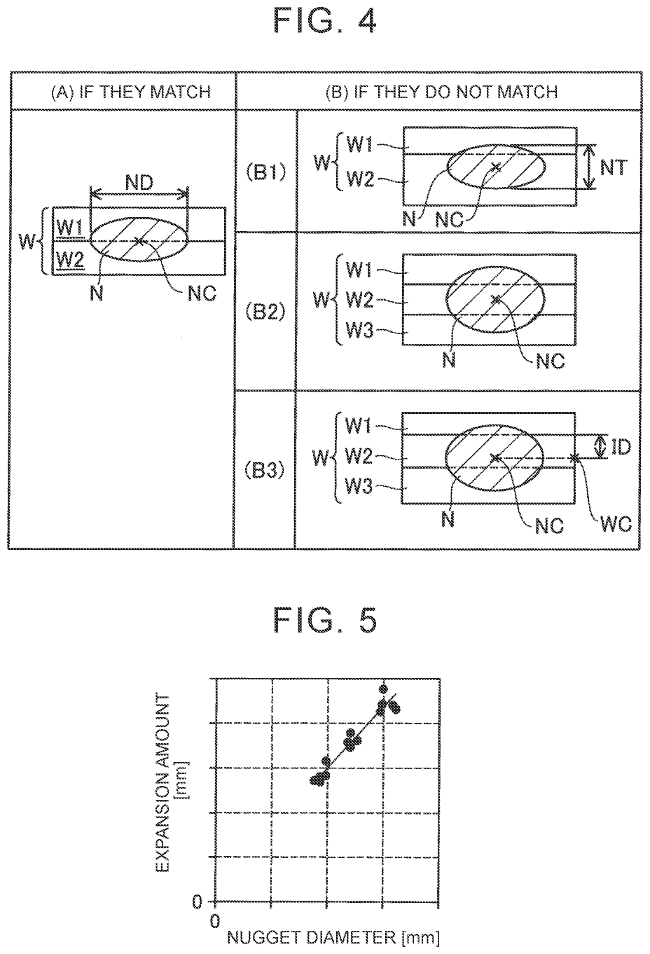

The cross-sectional shapes at the interface between the first metal plate W1 and the second metal plate W2 of the nugget N formed by the weld are generally circular. The nugget diameter ND (FIG. 4) is the diameter of the cross-sectional profile at the interface of the nugget N. The nugget diameter ND (FIG. 4) correlates with weld strength. Therefore, the nugget diameter ND is used to control weld qualities and the like. Instead of the actual measurement of the nugget diameter ND, an attempt has been made to estimate the nugget diameter ND using an estimation equation using physical quantities detected in the weld process. Here, the inventors have found that the accuracy of the estimation formula may not be sufficient.

FIG. 4 is a diagram for explaining a case where the accuracy of the estimation formula is insufficient. The present inventors have found that the accuracy of the estimation equation is insufficient when the nugget center NC does not coincide with the interface between two adjacent metal plates of the welded member W and the nugget N does not reach the farthest interface. The nugget center NC is the center of the nugget N. In the present embodiment, the center position of the welded member W in the thickness direction is regarded as the center position of the nugget N.

As shown in “(A) matching case” in FIG. 4, when the first metal plate W1 and the second metal plate W2 which are the welded members W are metal plates having the same thickness, the nugget center NC and the interface between the welded members W coincide with each other.

On the other hand, as shown in (B1) of “(B) not matching” in FIG. 4, when the first metal plate W1 and the second metal plate W2 as the welded member W are metal plates of differing thicknesses, the nugget center NC and the interface of the welded member W do not match. Further, as shown in (B2), when the welded member W is three sets of metal plates of the first metal plate W1, the second metal plate W2, and the third metal plate W3 having the same thickness as each other, the nugget center NC and the interface of the welded member W do not coincide with each other. Further, as shown in (B3), the welded member W is three sets of metal plates of the first metal plate W1, the second metal plate W2, and the third metal plate W3, when the first metal plate W1 and the third metal plate W3 and the thickness on both sides of the welded member W differ from each other, the nugget center NC and the interface of the welded member W do not coincide with each other.

Therefore, in the nugget diameter estimation process described in detail below, the nugget diameter ND is estimated when it is estimated that the nugget N has reached the farthest interface. Thus, it is possible to exclude the nugget diameter ND of the low-accuracy estimation that is calculated when the nugget N does not reach the interface. Therefore, it is possible to improve the estimation accuracy of the estimated nugget diameter ND.

Further, the inventors have found that the estimation accuracy of the nugget diameter ND is improved by adding, as a parameter, the displacement during the holding process P30 shown in FIG. 2 to the estimation equation of the nugget diameter ND. As shown in the holding process P30 of FIG. 3, the nugget N is crushed by the pressurization by the pair of electrode tips 21 and 22, and is deformed so that the nugget N spreads toward the interface. That is, the shape is deformed such that the nugget diameter ND becomes longer. Therefore, it is possible to improve the estimation accuracy of the nugget diameter ND by adding this displacement to the estimation equation of the nugget diameter ND.

In the nugget diameter ND estimation equation, in addition to the displacement amount in the period P30 the holding process, the displacement amount in the period of the energization process P20 and the electric resistance value in the energization process P20 are used. The electric resistance value is a value calculated by dividing the voltage between the pair of electrode tips 21 and 22 by the welding current. Specifically, the electric resistance value is a value calculated by dividing the voltage value detected by the voltage sensor 54 by the current value detected by the current sensor 53. In the present embodiment, as the electric resistance value in the energization process P20, the mean value of the electric resistance values from the time point of the end of the energization process P20 to the time point (FIG. 2) at which the predetermined acquisition-time GT is returned to the end of the energization process P20 is used. Note that the end point of the energization process P20 and the starting point of the holding process P30 are the same time points. The acquisition time GT is equal to or less than half of the process time of the energizing process P20. In the present embodiment, the process time of the energization process P20 is about 260 ms, and the acquisition time GT is about 30 ms. Since the displacement amount in the period of the energization process P20 and the electric resistance value in the acquisition time GT of the energization process P20 are in good proportional relation to the nugget diameter ND, these physical quantities are used in the estimation equation. Here, the displacement amount during the energization process P20 is referred to as an expansion amount. The amount of displacement during the holding process P30 is referred to as the contraction amount. As described above, in the present disclosure, the increasing amount of the distance between the pair of electrode tips 21 and 22 is used as the expansion amount of the welded member W in the thickness direction in the energization process P20. In addition, as the contraction amount of the welded member W in the thickness direction in the holding process P30, the amount of reduction in the distance between the pair of electrode tips 21 and 22 is used. As described above, the distance between the pair of electrode tips 21 and 22 is used as the thickness of the welded member W. This makes it possible to accurately detect the thickness of the welded member W.

The present inventors have confirmed that the measured value of the nugget diameter ND and each of the expansion amount, the contraction amount, and the electric resistance value are in a good proportional relation. FIG. 5 is a diagram illustrating a relation between an actual nugget diameter ND (mm) and an expansion amount (mm). Illustrated in FIG. 2, the characteristic line connecting the detected points of displacement, when regarded as a function showing the relation between the time and the amount of displacement, the integrated value during the period of the energization process P20, it is used as the expansion amount. As shown in FIG. 5, the measured nugget diameter ND (mm) and the expansion amount (mm) are in good positive proportionality.

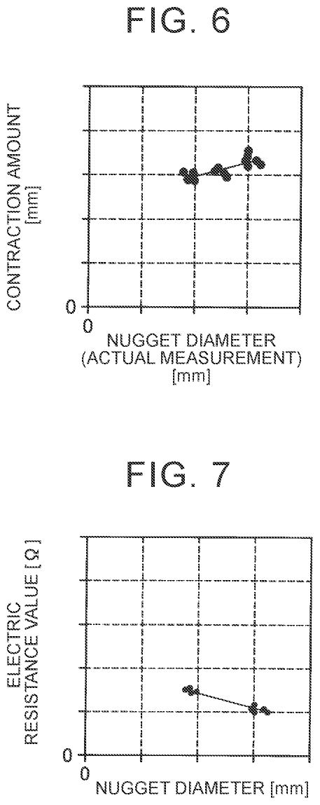

FIG. 6 is a diagram illustrating a relation between an actual nugget diameter ND and a contraction amount. A value obtained by subtracting the displacement amount at the end of the holding process P30 from the displacement amount at the start of the holding process P30 (FIG. 2) is used as the contraction amount. As shown in FIG. 6, the measured nugget diameter ND and the contraction amount are in good positive proportionality.

FIG. 7 is a diagram illustrating a relation between an actual nugget diameter ND (mm and an electric resistance value (a). As described above, the electric resistance value is the mean value of the electric resistance values from the time point (FIG. 2) returned from the end of the energization process P20 by the acquisition time GT to the time point at end of the energization process P20. As shown in FIG. 7, the measured nugget diameter ND (mm) and the electric resistance value (SI) are in good negative proportionality.

In the nugget diameter estimation process described later, the nugget thickness NT is also estimated using an estimation equation similar to the nugget diameter ND. That is, an estimation formula using the expansion amount, the contraction amount, and the electric resistance value as parameters is used. Similar to the nugget diameter ND, each of the expansion amount, the contraction amount, and the electric resistance value and the nugget thickness NT are in good proportionality.

In the nugget diameter estimation process described later, the nugget thickness NT and the nugget diameter ND are estimated using the estimation equation. The estimation formula is obtained by using a multiple regression method using an experimental result performed in advance in order to obtain the estimation formula. The nugget thickness estimation equation (1) is an equation for estimating the nugget thickness NT (mm). The nugget diameter estimation equation (2) is an equation for estimating the nugget diameter ND (mm). The nugget thickness estimation formula (1) and the nugget diameter estimation formula (2) are stored in a storage device included in the control device 80.

NT=C1×E+C2×S+C3×R+C4 (1)

ND=C5×E+C6×S+C7×R+C8 (2).

The parameters are as follows:
E (mm): Expansion amount
S (mm): Contraction amount
R (Ω): Electric resistance value
C1-C8: Constants

### A3. Estimation of Nugget Diameter

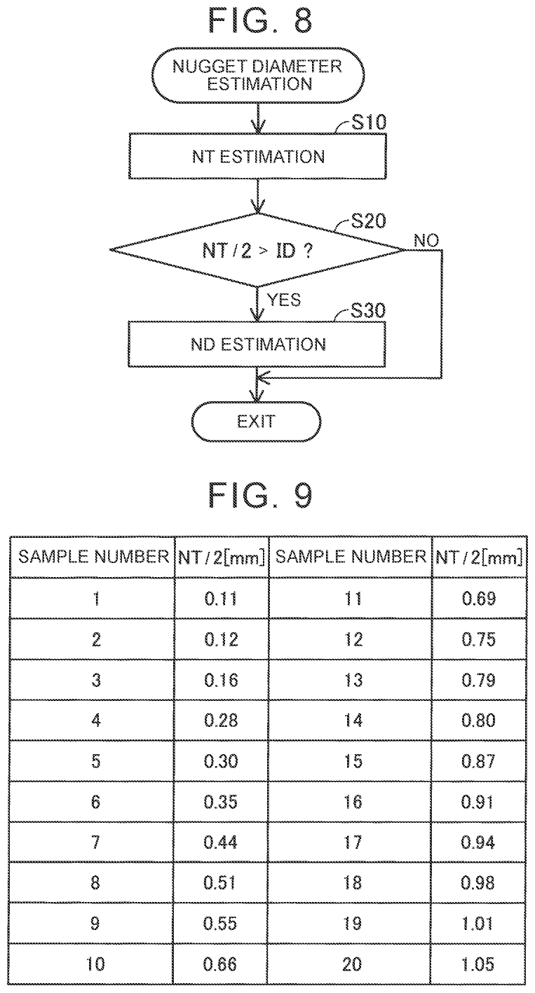

FIG. 8 is a flow chart of a nugget diameter estimation process for realizing a nugget diameter ND estimation method. In the welding process, the estimation unit 82 stores the detection values transmitted from the sensors in the storage device in association with the elapsed time from the start of welding. The storage device is provided in the control device 80. When the welding process is completed, the estimation unit 82 calculates the expansion amount, the contraction amount, and the electric resistance value using the stored detection value in the same manner as described above, and stores them in the storage device. Then, the estimation unit 82 estimates the nugget diameter ND using the calculated expansion amount, contraction amount, and electric resistance value. The calculation of the expansion amount, the contraction amount, and the electric resistance value may be performed when the subsequent step S10 is executed.

In the step S10 as the thickness estimation process, the estimation unit 82 estimates the nugget thickness NT by using the expansion amount, the contraction amount, and the electric resistance value calculated in advance and the nugget thickness estimation equation (1). In S20 of steps, the estimation unit 82 determines whether or not the nugget N has reached the interface. Specifically, the estimation unit 82 estimates that the nugget N has reached the interface when the length of half of the nugget thickness NT is longer than the range ID (FIG. 4). The distance ID is a distance between the center position WC (FIG. 4) of the welded member W in the thickness direction and the interface farthest from the center position WC.

When the estimation unit 82 determines that the nugget N has reached the interface (step S20:YES), the diameter estimation process proceeds to step S30. In the step S30, the estimation unit 82 estimates the nugget diameter ND by using the expansion amount, the contraction amount, and the electric resistance value calculated in advance and the nugget diameter estimation equation (2) described above. Then, the estimation unit 82 stores the estimated nugget diameter ND in the storage device of the control device 80, and ends this process routine.

On the other hand, when the estimation unit 82 determines that the nugget N has not reached the interface (S20:NO in steps), the estimation unit 82 ends the process without estimating the nugget diameter ND. According to this approach, the estimated nugget diameter ND is excluded from the estimated nugget diameter ND that is less accurate if the nugget N has not reached the interface. Therefore, the estimation accuracy of the nugget diameter ND can be improved.

### A4. First Embodiment

Three hot-dip galvanized steel sheets having a thickness 0.7 mm were superposed and spot-welded, and then the nugget diameter ND was estimated according to the above estimation methods. In the first embodiment and the second embodiment, the nugget diameter ND is defined differently from the above, and the length of the nugget N at the interface is used as the nugget diameter ND. The length of the nugget N at the interface here is a distance from one intersection point of two intersection points of the nugget N and the interface of one metal plate to the other intersection point in the nugget N appearing in a cross section that passes through the nugget center NC and has a plane parallel to the thickness direction of the welded member W as a cut surface. The nugget diameter ND is correlated with the length of the nugget N at the interface. Therefore, the length of the nugget N at the interface can be regarded as the nugget diameter ND, and the above estimation methods can be applied. That is, the length of the nugget N at the interface is an aspect of the nugget diameter ND.

The number of samples is 20. Within the welding condition, the pressurization condition was not changed, and the welding was carried out by setting various conditions of the welding current. Specifically, four current patterns in which the current value of the welding current was changed were prepared and welded.

FIG. 9 is the result of half the length of the estimated nugget diameter ND. For convenience, the values are arranged in order of length in the nugget diameter ND. Since a metal plate having a thickness 0.7 mm is used, the range ID is 0.35 mm. In Example 1, of the 20 samples, 6 samples are less than or equal to 0.35 mm. Therefore, the nugget diameter ND was estimated by excluding the samples below 0.35 mm.

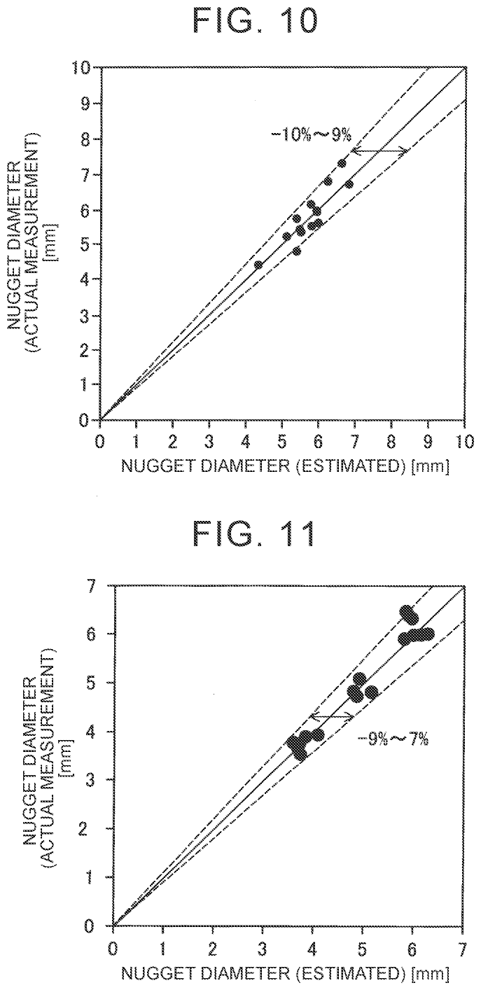

FIG. 10 is an estimated nugget diameter ND according to Embodiment 1. The horizontal axis of FIG. 10 is the estimated nugget diameter (mm). The vertical axis in FIG. 11 represents the actual nugget diameter (mm). The same applies to FIG. 11 described later.

As shown in FIG. 10, the estimation method of the first embodiment has improved accuracy over the estimation method that does not exclude the case where the nugget N is estimated not to have reached the interface. The nugget diameter ND can be estimated with an accuracy of −10% or more and 9% or less.

### A5. Second Embodiment

A hot-dip galvanized steel sheet having a thickness 1.8 mm and a hot-dip galvanized steel sheet having a thickness 0.9 mm were superimposed and spot-welded. The nugget diameter ND was then estimated according to the above estimation methods. In Example 2, in the same manner as in Example 1, the welding was performed by setting various conditions of the welding current without changing the pressurizing conditions.

FIG. 11 shows a nugget diameter ND of the estimation according to the second embodiment. The estimation method of Example 2 was more accurate than the estimation method in which no contraction amount was added to the parameter of the estimation formula. The nugget diameter ND can be estimated with accuracy ranging from −9% to 7%.

According to the embodiment described above, the nugget thickness NT is estimated in the step S10, and it is estimated that the nugget N has reached the interface using the estimated nugget thickness NT. Here, the nugget diameter ND is estimated by the step S20. Therefore, it is possible to exclude the nugget diameter ND of the low-accuracy estimation that is calculated when the nugget N has not reached the interface. Therefore, it is possible to improve the estimation accuracy of the estimated nugget diameter ND.

In addition, in the step S10, the nugget thickness is estimated using the contraction amount in addition to the expansion amount and the electric resistance value. In the step S30, the nugget diameter ND is estimated by using the contraction amount in addition to the expansion amount and the electric resistance value. Therefore, the nugget thickness NT and the nugget diameter ND are estimated by using the respective nugget thickness NT and nugget diameter ND and the contraction amounts having a good proportional relation. Thus, the estimation accuracy can be further improved.

Further, as the contraction amount, a value obtained by subtracting the thickness of the welded member W at the end of the holding process P30 from the thickness of the welded member W at the start of the holding process P30 is used. As a result, it is possible to reduce the load applied to the calculation of the contraction amount. The electric resistance value used in the estimation equation is an averaged electric resistance value from the time point returned from the end point of the energization process P20 by the acquisition time GT to the end point of the energization process P20. The acquisition time GT is equal to or less than half of the process time of the energizing process P20. Since the mean of the electric resistance value and the nugget thickness NT and the nugget diameter ND are well correlated with each other, the estimation accuracy can be further improved.

In addition, in the step S20, if the estimated length of half of the nugget thickness NT is longer than the range ID, it is estimated that the nugget N has reached the interface. The distance ID is a distance between the center position WC of the welded member W and the interface farthest from the center position WC. Therefore, it is possible to estimate whether or not the nugget N has reached the interface by using the range ID determined by the thickness of the welded member W.

Further, in the step S10, the nugget thickness estimation equation (1) is used. In the step S30, the nugget diameter estimation equation (2) is used. As a result, an estimation equation reflecting a proportional relation between each of the nugget thickness NT and the nugget diameter ND and the expansion amount, the contraction amount, and the electric resistance value is used. This makes it possible to accurately estimate the nugget thickness NT and the nugget diameter ND.

### B. Other Embodiments

(B1) Using the above estimation method, a determination method of determining a welding defect can be performed. In the nugget diameter estimation process, when it is determined that the nugget N has not reached the interface (S20: NO in steps), the estimation unit 82 may determine that the nugget N has failed to be welded. The estimation unit 82 may store the determination value of the welding failure in the storage device included in the control device 80. This makes it possible to appropriately determine the welding quality.

(B2) In the above-described embodiment, the contraction amount is used as a parameter in each of the nugget thickness estimation formula (1) and the nugget diameter estimation formula (2). However, the contraction amount may not be used as a parameter. When estimating each of the nugget thickness estimation formula (1) and the nugget diameter estimation formula (2), at least the expansion amount and the electric resistance value are used. Thus, each of the nugget thickness NT and the nugget diameter ND can be estimated.

(B3) In the above-described embodiment, as the contraction amount, a value obtained by subtracting the displacement amount at the end of the holding process P30 from the displacement amount indicating the thickness of the welded member W at the beginning of the holding process P30 is used. The contraction amount is not limited to this. The contraction amount may be, for example, an integral value calculated in the same manner as the expansion amount.

(B4) In the above-described embodiment, the electric resistance values used in the respective estimation formulas are averages of the electric resistance values from the time point returned from the end of the energization process P20 by the acquisition time GT to the end of the energization process P20. However, the electrical resistance value is not limited thereto. For example, the electrical resistance value may be a mean of the electrical resistance values over the entire duration of the energization process P20. The electrical resistance value may be not an average but an electrical resistance value at a predetermined time point.

The present disclosure is not limited to the above-described embodiments. Various configurations can be implemented without departing from the spirit of the present disclosure. For example, the technical features of the embodiments corresponding to the technical features in the embodiments described in SUMMARY can be appropriately replaced or combined in order to solve some or all of the above-described problems or to achieve some or all of the above-described effects. Further, when the technical features are not described as essential in the present specification, these can be deleted as appropriate.

What is claimed is:

1. An estimation method for a nugget diameter of a nugget formed by resistance spot welding including a first process and a second process, the first process being a process of pressurizing two or more metal plates that are laminated by being interposed between paired electrode tips and applying energization and the second process being a process of stopping the energization in the first process and pressurizing the two or more metal plates with the paired electrode tips, the estimation method comprising:
a thickness estimation process of estimating a nugget thickness using an expansion amount in a thickness direction of the two or more metal plates in the first process and an electric resistance value between the paired electrode tips in the first process; and
a diameter estimation process of estimating the nugget diameter using the expansion amount and the electric resistance value when the nugget is estimated to reach an interface between two of the metal plates adjacent to each other using a thickness of each of the two or more metal plates and the estimated nugget thickness.

2. The estimation method according to claim 1, wherein:
the thickness estimation process includes estimating the nugget thickness using a contraction amount in the thickness direction of the two or more metal plates in the second process, in addition to the expansion amount and the electric resistance value; and
the diameter estimation process includes estimating the nugget diameter using the contraction amount, in addition to the expansion amount and the electric resistance value.

3. The estimation method according to claim 2, wherein the contraction amount is a value obtained by subtracting a thickness of the two or more metal plates at an end of the second process from a thickness of the two or more metal plates at a start of the second process.

4. The estimation method according to claim 2, wherein:
the electric resistance value is an average of the electric resistance value from a time point returned from a time point at an end of the first process by a predetermined acquisition time to the time point at the end; and
the acquisition time is less than or equal to half a process time of the first process.

5. The estimation method according to claim 1, further comprising estimating that the nugget reaches the interface when a half length of the estimated nugget thickness is longer than a distance between a center position in the thickness direction of the two or more metal plates and the interface that is farthest away from the center position.

6. The estimation method according to claim 2, wherein:
when the nugget thickness is NT (mm), the nugget diameter is ND (mm), the expansion amount is E (mm), the contraction amount is S (mm), the electric resistance value is R (Ω), and predetermined constants are C1 to C8,
the thickness estimation process includes obtaining the nugget thickness using an equation (1) below; and
the diameter estimation process includes obtaining the nugget diameter using an equation (2) below, where
NT=C1×E+C2×S+C3×R+C4 (1)
ND=C5×E+C6×S+C7×R+C8 (2).

7. A determination method using the estimation method according to claim 1, further comprising determining that a welding failure occurs when the nugget is estimated not to reach the interface using the thickness of each of the two or more metal plates and the estimated nugget thickness.
